(19) United States
(12) Patent Application Publication
(10) Pub. No.: US 2025/0153792 A1
(43) Pub. Date: May 15, 2025

(54) ASSEMBLY SYSTEM FOR CRASH PAD LOWER ASSEMBLY PANEL

(71) Applicant: DO LIM INDUSTRY CO., LTD., Ulsan (KR)

(72) Inventors: Sung Gye PARK, Gyeonggi-do (KR); Seong Ju KIM, Ulsan (KR); Young Taek SONG, Ulsan (KR); Young Hun LEE, Ulsan (KR); Nam Kyu KIM, Ulsan (KR); Ki Young KIM, Ulsan (KR); Sang Cho LEE, Ulsan (KR); Ki Yeol KIM, Ulsan (KR)

(21) Appl. No.: 18/941,637

(22) Filed: Nov. 8, 2024

(30) Foreign Application Priority Data
Nov. 13, 2023 (KR) 10-2023-0156268

(51) Int. Cl. B62D 65/02; B23P 19/00; B25J 11/00

(52) U.S. Cl. CPC B62D 65/026; B23P 19/001; B25J 11/005

(57) ABSTRACT

Proposed is an assembly system for a crash pad lower assembly panel, the assembly system being capable of automatically aligning and supplying fasteners and assembling accessories to a crash pad lower assembly panel using the fasteners. An assembly system for a crash pad lower assembly panel according to an embodiment includes a work table, a jig provided on a first side of the upper surface of the work table and configured to support a front surface of the crash pad lower assembly panel, a pressing rod provided on the work table and configured to pressurize the crash pad lower assembly panel supported on the jig, an orthogonal robot provided on the work table and configured to be movable in the X-axis and Y-axis above the jig, and an assembly device coupled to the orthogonal robot.

### CROSS REFERENCE TO RELATED APPLICATION

The present application claims priority to Korean Patent Application No. 10-2023-0156268, filed Nov. 13, 2023, the entire contents of which is incorporated herein for all purposes by this reference.

### BACKGROUND OF THE INVENTION

### Field of the Invention

The present disclosure relates to an assembly system for a crash pad lower assembly panel.

### Description of the Related Art

A crash pad lower assembly panel is a component that is attached to a lower part of a vehicle's steering wheel, is located in front of driver's knees, and covers a vehicle's fuse box. Referring to Korean Patent No. 10-1026985, the general shape and position of a crash pad lower assembly panel (indicated as “crash pad 10” in this patent document) is described.

Referring to FIG. 12, which is an exploded view of a crash pad lower assembly panel CP, various accessories P, P′, and P″, such as an ON BOARD DIAGNOSTICS (OBD) bracket, are assembled onto the crash pad lower assembly panel CP by fasteners F. In an attempt to quickly and accurately assemble the various accessories P, P′, and P″ onto the crash pad lower assembly panel CP, automatic assembly devices or systems are being developed. However, in order for the automatic assembly device to automatically assemble fasteners that fasten a crash pad lower assembly panel and accessories, the device needs to be able to automatically supply fasteners. For this purpose, a supply device that automatically aligns and supplies fasteners is essential.

Korean Patent No. 10-2396391 discloses an automatic bolt fastening device for furniture.

The automatic bolt fastening device for furniture disclosed in this patent document includes: a device body 2 installed with a vertical length relative to the floor; a work table 4 provided on a part of the device body 2, and having a work plate 41 on which a jig means 3 is mounted to support a workpiece 100 in a correct posture; a fastening means 5 provided above the work table 4 on the device body 2 and fastening a bolt 10 by lifting and lowering the bolt 10 while rotating it with respect to the attachment piece 110 that is input onto a surface of the workpiece 100; and a bolt supplier 200 supplying the bolt 10 to the fastening means 5. The fastening means 5 includes: a main lifting body 51 disposed with a gap above the work table 4 on the device body 2; a main lifting member 52 having a lifting driver provided with a lifting motor 521 that is provided on a fixed base 22 of the device body 2 to reciprocate the main lifting body 51 vertically linearly through control of a control means 61 that controls power of a power supplier 62 and is driven by control of the control means 61 to generate a forward and reverse rotational force, and a lifting screw rod 523 that is screw-connected with a lifting nut tube 522 provided on the main lifting body 51 and is rotated forward and backward to selectively lift and lower the main lifting body 51 by receiving the rotational force from the lifting motor 521; a supply member 55 provided under a rotary tube 54, connected to an inlet tube 552 that receives the bolt 10 supplied to one side, and having a supply tube 551 having a sleeve shape with open upper and lower ends and allowing the bolt 10 introduced therein to be aligned in an upright state, the rotary tube 54 having a sleeve shape with open upper and lower ends, being coupled to the main lifting body 51, and receiving a rotary rod 53 therein that is coupled to a screw head of the bolt 10 to rotate the bolt 10; a rotary member 57 having a rotary connector that transmits a rotational force generated from a rotary motor 56 through control of the control means 61 to the rotary rod 53 disposed inside the rotary tube 54 to selectively rotate the rotary rod 53; an auxiliary lifting body 58 disposed with a gap above the main lifting body 51 on the device body 2 and to which the rotary member 57 is fixed; and an auxiliary lifting member 59 having an auxiliary lifting drive that vertically reciprocates the auxiliary lifting body 58 through control of the above control means 61 to selectively lift and lower the rotary member 57 and lift and lower the rotary rod 53 inside the rotary tube 54.

The bolt supplier of the automatic bolt fastening device for furniture align bolts while rotating a cylinder storing the bolts continuously at a constant speed, and thus is problematic in that it takes a long time to supply the bolts and the bolt supplier is bulky.

The foregoing is intended merely to aid in the understanding of the background of the present disclosure, and is not intended to mean that the present disclosure falls within the purview of the related art that is already known to those skilled in the art.

### Documents of Related Art

(Patent document 1) Korean Patent Application Publication No. 10-2020-0033407 (published on Mar. 30, 2020)
(Patent document 2) Korean Patent 10-2396391 (registered on May 4, 2022)

### SUMMARY OF THE INVENTION

Accordingly, the present disclosure has been made keeping in mind the above problems occurring in the related art, and one objective of the present disclosure is to provide an assembly system for a crash pad lower assembly panel, the assembly system being capable of automatically aligning and supplying fasteners and assembling accessories to a crash pad lower assembly panel using the fasteners.

In order to achieve the above objective, according to one aspect of the present disclosure, there is provided an assembly system that assembles accessories to a crash pad lower assembly panel using fasteners, the assembly system including: a work table; a jig provided on a first side of the upper surface of the work table and configured to support a front surface of the crash pad lower assembly panel; a pressing rod provided on the work table and configured to pressurize the crash pad lower assembly panel supported on the jig; an orthogonal robot provided on the work table and configured to be movable in the X-axis and Y-axis above the jig; and an assembly device coupled to the orthogonal robot.

Additionally, the assembly device of the assembly system may include: a main frame coupled to the orthogonal robot; a rail having a first side coupled to a lower end of the main frame and a second side inclined so as to be located higher than the first side, and having a guide groove formed longitudinally on an upper side thereof and configured to guide the fasteners; a storage box provided at a second end of the rail and configured to store the fasteners therein; a supply unit configured to be lifted in the storage box and supply the fasteners stored in the storage box to the guide groove located at the second end of the rail; a holding plate coupled to the lower end of the main frame and located apart from a first end of the rail; a withdrawal unit coupled to the lower end of the main frame and configured to individually withdraw one by one the fasteners received in the guide groove located at the first end of the rail to the holding plate; and an assembly driver coupled to the main frame so as to be movable upward and downward and configured to assemble a fastener located in the holding plate by lowering the fastener.

Additionally, the supply unit of the assembly system may include: a fan-shaped plate coupled to a lower portion of the second side of the rail, with an arc portion thereof facing downward; a rotary bar having a first side located outside the fan-shaped plate and a second side axially coupled to a center of the fan-shaped plate so as to be rotatable; and a rotary plate having a first side coupled to the first side of the rotary bar and a second side located in the storage box, and having a receiving groove formed on the second side thereof and configured to allow the fasteners to be received therein.

Additionally, the withdrawal unit of the assembly system may include: a rotary frame axially coupled to the lower end of the main frame; a leg frame extending downward from the rotary frame; and a stopper coupled to an end of the leg frame and configured to restrict movement of the fasteners located at the first end of the rail.

Additionally, the assembly system may further include: an alignment unit located above the rail and configured to be moved along the rail to align the fasteners received in the guide groove. The alignment unit may include: a sliding bar located above the rail and configured to be movable along the rail; a pusher located above the second end of the rail and coupled to the sliding bar; and a groove formed in the pusher and having a shape corresponding to each of the fasteners.

Additionally, the assembly system may further include: a refill unit provided on the work table and configured to refill the fasteners into the storage box. The refill unit may include: a support installed on an edge of the work table; a refill box installed at an upper end of the support and inclined so that a first side thereof adjacent to the storage box is located lower than a second side thereof; a lifting block configured to be lifted along an inner side surface of the refill box; a discharge port extending outward and downward from a side of an upper end of the refill box; and a door installed at an end of the discharge port so as to be openable and closable.

Additionally, the pressing rod of the assembly system may include: an actuator installed on the work table so that a shaft thereof is disposed orthogonal to the work table; a support coupled orthogonal to the shaft and configured to be rotated and lifted by the actuator; and a pressure block extending downward from an end of the support.

The assembly device of the assembly system for the crash pad lower assembly panel according to the embodiment can be freely moved by a robot arm. Additionally, each component of the assembly system for the crash pad lower assembly panel according to the embodiment can be controlled for operation by various sensors. This enables quick and accurate assembly of the crash pad lower assembly panel.

Additionally, in the assembly device of the assembly system for the crash pad lower assembly panel according to the embodiment, when the fasteners stored in the storage box are lifted by the rotary plate, only the fasteners received in the receiving groove of the rotary plate can be guided to the guide groove. This enables easy supply of the fasteners to the rail.

Additionally, in the assembly device of the assembly system for the crash pad lower assembly panel according to the embodiment, only the fasteners received in the guide groove and the receiving groove can be guided to the rail due to reciprocating motion of the alignment unit and the groove of the alignment unit. This enables easy alignment of the fasteners.

Additionally, the assembly device of the assembly system for the crash pad lower assembly panel according to the embodiment can supply the fasteners to the rail without malfunction due to its simple structure.

Additionally, the assembly device of the assembly system for the crash pad lower assembly panel according to the embodiment can have a smaller volume than a conventional supply device, so it can be installed together with a robot arm, and it does not require much installation space and can be installed even in a narrow space area.

Additionally, the refill unit of the assembly system for the crash pad lower assembly panel according to the embodiment can be installed outside the operating range of the orthogonal robot, so it can be prevented from interfering with the operation of the assembly device. Additionally, the door can be opened only when necessary by a sensor to refill the fasteners into the storage box.

### BRIEF DESCRIPTION OF THE DRAWINGS

The above and other objectives, features, and other advantages of the present disclosure will be more clearly understood from the following detailed description when taken in conjunction with the accompanying drawings, in which:

FIG. 1 is a perspective view illustrating an assembly system for a crash pad lower assembly panel according to an embodiment;

FIG. 2 is a perspective view illustrating a pressing rod according to the embodiment;

FIG. 3 is a perspective view illustrating an assembly device according to the embodiment;

FIG. 4 is an exploded view illustrating the assembly device according to the embodiment;

FIG. 5 is a view illustrating a state in which fasteners are aligned and supplied by the assembly device according to the embodiment;

FIG. 6 is a view illustrating a state in which the fasteners are aligned and supplied by the assembly device according to the embodiment;

FIG. 7 is a view illustrating a state in which the fasteners are assembled by the assembly device according to the embodiment;

FIG. 8 is a view illustrating a state in which the fasteners are assembled by the assembly device according to the embodiment;

FIG. 9 is a view illustrating a state in which the fasteners are assembled by the assembly device according to the embodiment;

FIG. 10 is a view illustrating a state in which fasteners are supplemented by a refill unit according to the embodiment;

FIG. 11 is a view illustrating a state in which the fasteners are supplemented by the refill unit according to the embodiment; and

FIG. 12 is an exploded view illustrating a crash pad lower assembly panel.

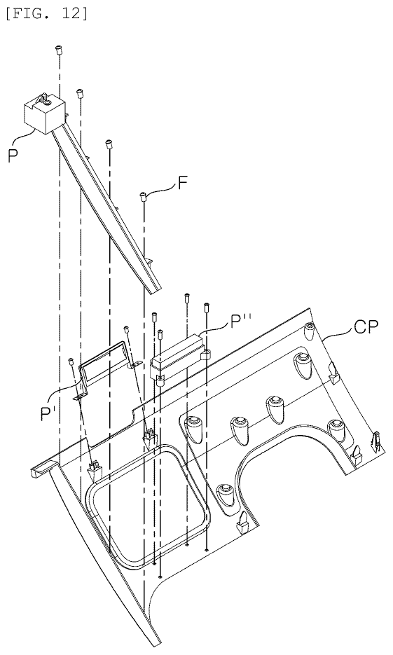

### DETAILED DESCRIPTION OF THE INVENTION

The present disclosure, advantages of the present disclosure, and objectives achieved by the present disclosure will become apparent from the detailed description of the following embodiments in conjunction with the accompanying drawings. However, it should be understood that the present disclosure is not limited to the following embodiments and may be embodied in different ways, and that the embodiments are given to provide complete disclosure of the inventive concept and to provide a thorough understanding of the present disclosure to those skilled in the art. The scope of the present disclosure is defined only by the claims. Throughout the drawings, the same reference numerals will refer to the same or like parts.

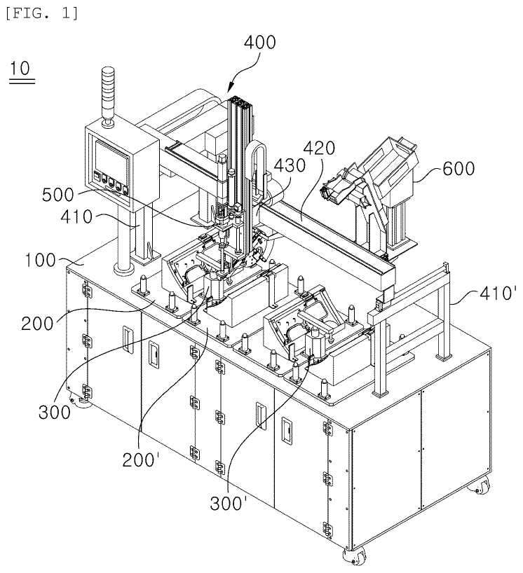

Referring to FIG. 1, which is a perspective view of an assembly system 10 for a crash pad lower assembly panel according to an embodiment (hereinafter referred to as “assembly system 10”), the assembly system 10 includes a work table 100, a jig 200, a pressing rod 300, an orthogonal robot 400, and an assembly device 500.

The work table 100 is installed on the floor and has a flat upper surface. Additionally, the work table 100 may be manufactured in a booth shape with an enclosed upper surface for the safety of workers during work, and may be movable using casters.

The jig 200 is installed on a first side of the upper surface of a work table 100, and allows a crash pad lower assembly panel CP to be placed thereon. Specifically, the jig 200 supports the crash pad lower assembly panel CP with a front surface of the crash pad lower assembly panel CP facing downward.

Additionally, the jig 200 may be provided with a sensor (not illustrated) that recognizes placement of the crash pad lower assembly panel CP.

Additionally, a pair of jigs 200 may be symmetrically provided on a second side of the upper surface of the work table 100.

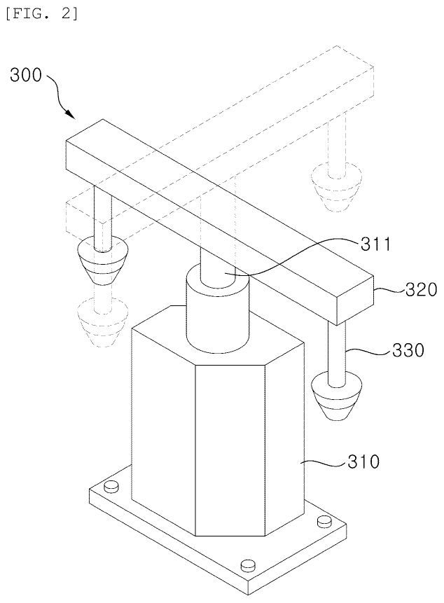

Referring to FIG. 2, which is a perspective view of the pressing rod 300, the pressing rod 300 is provided on the work table 100 and pressurizes the crash pad lower assembly panel CP placed on the jig 200.

As an example, the pressing rod 300 may include an actuator 310, a support 320, and a pressure block 330.

The actuator 310 is installed on the upper surface of the work table 100, and has a shaft 311 disposed orthogonal to the upper surface of the work table 100.

The support 320 is coupled orthogonal to the shaft 311. That is, the support 320 has a parallel relationship with the upper surface of the work table 100. Additionally, the support 320 is rotated and lifted by the actuator 310.

The pressure block 330 extends downward from an end of the support 320. A lower end of the pressure block 330 is brought in to direct contact with the crash pad lower assembly panel CP, so the pressure block 330 may be made of a material such as rubber or silicone. Additionally, when the pair of jigs 200 are provided, the pressure block 330 may be provided at each end of the support 320.

The orthogonal robot 400 is provided on the work table 100 and is movable in the X-axis and Y-axis above the jig 200. As an example, the orthogonal robot 400 may include a pair of X-axis rails 410, an Y-axis rail 420, and a robot arm 430.

The X-axis rails 410 are symmetrically provided on opposite edges of the upper surface of the work table 100.

The Y-axis rail 420 has opposite ends respectively coupled to the X-axis rails 410 so as to be movable along the X-axis rails 410, and is located above the jig 200.

The robot arm 430 is coupled to the Y-axis rail 420 so as to be movable along the Y-axis rail 420, and is located above the jig 200.

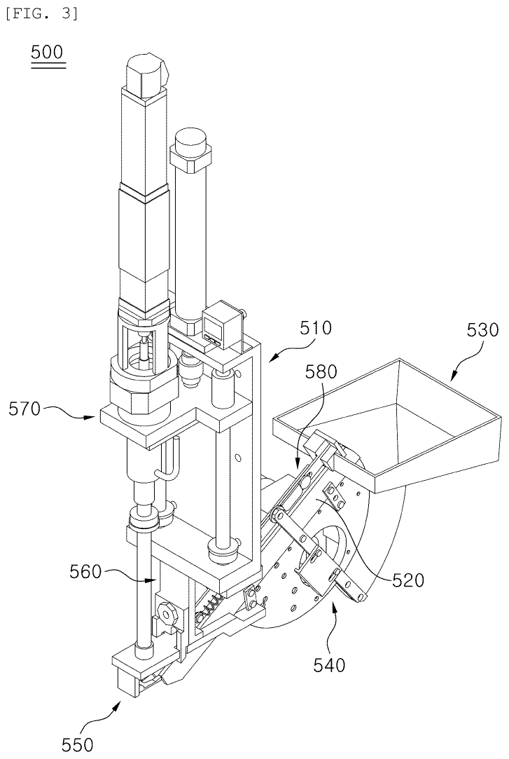

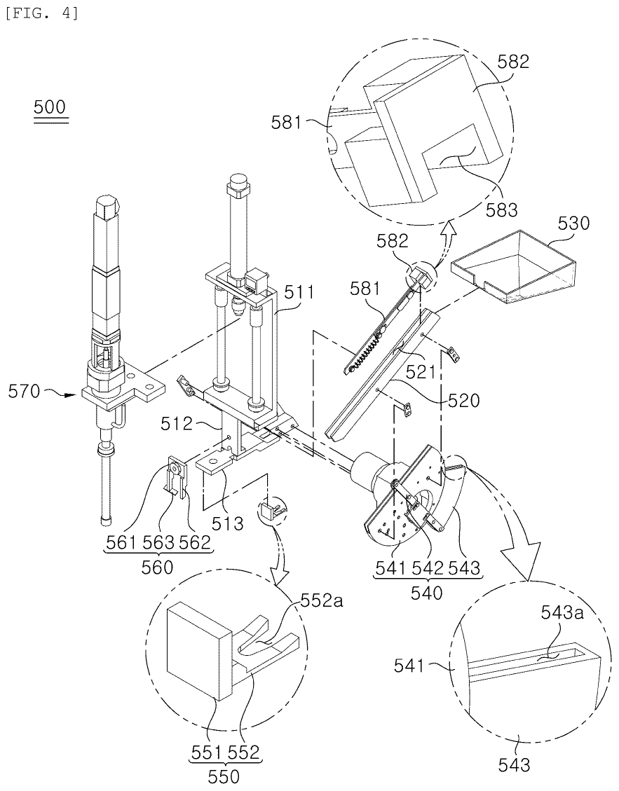

Referring to FIG. 3, which is a perspective view of the assembly device 500, and FIG. 4, which is an exploded view of the assembly device 500, the assembly device 500 includes a main frame 510, a rail 520, a storage box 530, a supply unit 540, a holding plate 550, a withdrawal unit 560, and an assembly driver 570.

The main frame 510 may be configured as frames having various shapes, and may be mounted on a tip of the robot arm 430 so as to be movable by the robot arm 430. As an example, the main frame 510 may include a first frame 511, a second frame 512, and a third frame 513.

The first frame 511 is a “C” shaped frame. A body portion of the first frame 511 is mounted on the tip of the robot arm 430 while opposite ends of the first frame 411 are located in the vertical direction. A first end of the first frame 511 may be located upward and may be provided with various sensors such as a photo sensor and an approach detection sensor.

The second frame 512 extends downward from a second end of the first frame 511. The second frame 512 may have a narrower area than the first frame 511.

The third frame 513 is coupled orthogonal to the second frame 512. That is, the third frame 513 is in a horizontal state. The third frame 513 has a hole formed on a side thereof to allow an end of the assembly driver 570, which will be described later, to pass therethrough.

The rail 520 is inclined so that a first side thereof is coupled to a lower end of the main frame 510 and a second side thereof is located higher than the first side thereof. Additionally, the rail 520 has a guide groove 521 formed longitudinally on an upper side thereof to guide fasteners F. Accordingly, the fasteners F received in the guide groove 521 are guided from the second side to the first side of the rail 520 by gravity. Additionally, the rail 520 may be provided with a sensor (not illustrated) that checks the fasteners F received in the guide groove 521.

The guide groove 521 has a width capable of receiving a body FB of each of the fasteners F, and a head FH of each of the fasteners F is not received in the guide groove 521.

The storage box 530 is provided at a second end of the rail 520 and stores the fasteners F therein. The storage box 530 has a slit formed at a lower portion thereof to allow a second side of a rotary plate 543 of the supply unit 540, which will be described later, to pass therethrough. Additionally, the storage box 530 may be provided with a sensor (not illustrated) that checks the fasteners F stored therein.

The supply unit 540 is lifted inside the storage box 530 and supplies the fasteners F stored in the storage box 530 to the guide groove 521 located at the second end of the rail 520. As an example, the supply unit 540 may include a fan-shaped plate 541, a rotary bar 542, and the rotary plate 543.

The fan-shaped plate 541 is coupled to a lower portion of the second side of the rail 520, with an arc portion thereof facing downward. The fan-shaped plate 541 may have a semicircular shape to correspond to the rail 520.

The rotary bar 542 has a first side located outside the fan-shaped plate 541 and a second side axially coupled to the center of the fan-shaped plate 541. That is, the first side of the rotary bar 542 is moved along the arc portion of the fan-shaped plate 541 with the center of the fan-shaped plate 541 as the axis.

The rotary plate 543 has a first side coupled to the first side of the rotary bar 542 and a second side located in the lower slit of the storage box 530. Additionally, the rotary plate 543 has a receiving groove 543a formed on the second side thereof to receive the fasteners F. The receiving groove 543a has a width capable of receiving the body FB of each of the fasteners F, and the head FH of each of the fasteners F is not received in the receiving groove 543a.

As an example, the rotary plate 543 may have a shape corresponding to a lateral surface of a truncated cone in a development drawing of the truncated cone, with a first slant side coupled to the first side of the rotary bar 542 and a second slant side located in the lower slit of the storage box 530. At this time, a short curved portion of the rotary plate 543 has the same curvature as the arc portion of the fan-shaped plate 541. Additionally, when the rotary plate 543 is lifted to its maximum height, the second slant side of the rotary plate 543 forms a straight line with the rail 520 so that the receiving groove 543a and the guide groove 521 communicate with each other. Accordingly, the rotary plate 543 is lifted inside the storage box 530 by rotation of the rotary bar 542 while the fasteners F are received in the receiving groove 543a, and the fasteners F received in the receiving groove 543a are supplied to the guide groove 521 located on the second side of the rail 520 by gravity.

The holding plate 550 is coupled to the lower end of the main frame 510 and is located apart from a first end of the rail 520. As an example, the holding plate 550 may include an extension plate 551 and a leg plate 552.

The extension plate 551 is formed to extend downward from the third frame 513 of the main frame 510 and is located apart from the first end of the rail 520.

The leg plate 552 is located directly below the third frame 513 and is hinged to an end of the extension plate 551 so as to be rotatable downward in a horizontal state. Additionally, the leg plate 552 has a holding groove 552a for receiving the body FB of each of the fasteners F. The holding groove 552a is formed by opening a side of the leg plate 552 facing the first end of the rail 520.

The withdrawal unit 560 is coupled to the lower end of the main frame 510 and individually withdraws one by one the fasteners F received in the guide groove 521 located at the first end of the rail 520 to the holding plate 550. The withdrawal unit 560 includes a rotary frame 561, a leg frame 562, and a stopper 563.

The rotary frame 561 is axially coupled to the second frame 512 of the main frame 510.

The leg frame 562 extends downward from the rotary frame 561.

The stopper 563 is coupled to an end of the leg frame 562 and has an end located in the guide groove 521 located on the first side of the rail 520. The stopper 563 restricts movement of the fasteners F received in the guide groove 521 located at the first end of the rail 520 by being inserted into or removed from the guide groove 521 located at the first end of the rail 520 by rotation of the rotary frame 561.

The assembly driver 570 is coupled to the main frame 510 so as to be movable upward and downward, and has an end located directly above the holding groove 552a of the holding plate 550. The assembly driver 570 is moved downward to receive a fastener F located in the holding plate 550 and assemble the fastener F to a workpiece. The assembly driver 570 may be moved upward and downward by a hydraulic cylinder provided on the main frame 510. Additionally, the assembly driver 570 may be provided with a sensor (not illustrated) that checks whether a fastener F exists at a fastening position of the fastener F on the crash pad lower assembly panel CP.

Additionally, the assembly device 500 may further include an alignment unit 580.

The alignment unit 580 is located above the rail 520 and is moved along the rail 520 to align the fasteners F received in the guide groove 521. As an example, the alignment unit 580 includes a sliding bar 581, a pusher 582, and a groove 583.

The sliding bar 581 is located above the rail 520 and is movable along the rail 520.

The pusher 582 is located above the second end of the rail 520 and is coupled to the sliding bar 581 so as to movable along the rail 520 together with the sliding bar 581.

The groove 583 is formed in the pusher 582 and has a shape corresponding to the head FH of each of the fasteners F. Accordingly, the pusher 582 is reciprocally moved by the sliding bar 581, thereby aligning the fasteners F by pushing out the fasteners F coming out of the guide groove 521 located on the second side of the rail 520. That is, only the fasteners F in which the body FB is received in the guide groove 521 and the head FH passes through the groove 583 remain, and the remaining fasteners F are dropped back into the storage box 530 by the pusher 582.

Additionally, the assembly device 500 may further include a refill unit 600.

The refill unit 600 is provided on the work table 100 and refills the fasteners F to the storage box 530. As an example, the refill unit 600 may include a support 610, a refill box 620, a lifting block 630, a discharge port 640, and a door 650.

The support 610 has a pillar shape and is installed at an edge of the work table 100. The support 610 may be located outside the work table 100.

The refill box 620 is installed at an upper end of the support 610 and stores the fasteners F therein. The refill box 620 is inclined so that a first side thereof adjacent to the storage box 530 is located lower than a second side thereof. That is, the refill box 620 is inclined toward an inner side of the upper surface of the work table 100.

The lifting block 630 is lifted along an outer side surface or an inner side surface of the refill box 620. When the lifting block 630 is located on the outer side surface of the refill box 620, the side surface of the refill box 620 may be open with an area corresponding to the lifting block 630. Accordingly, the fasteners F stored on the first side of the refill box 620 are lifted together with the lifting block 630 when the lifting block 630 is lifted.

The discharge port 640 extends outward and downward from a side of an upper end of the refill box 620. The discharge port 640 may become narrower as it is away from the refill box 620 to guide the fasteners F lifted by the lifting block 630.

The door 650 is installed at an end of the discharge port 640 so as to be openable and closable. Additionally, the door 650 may be provided with a sensor (not illustrated). The sensor may detect access to the storage box 530 and determine whether the door 650 is opened or closed.

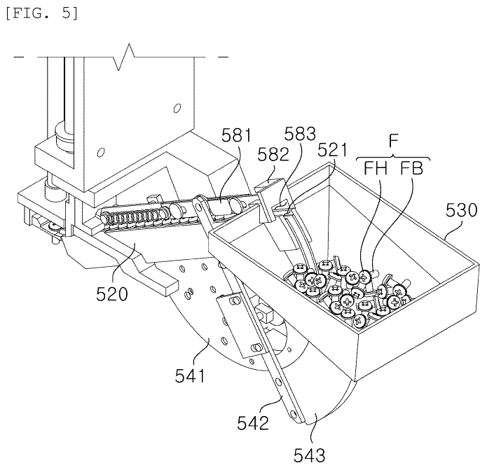

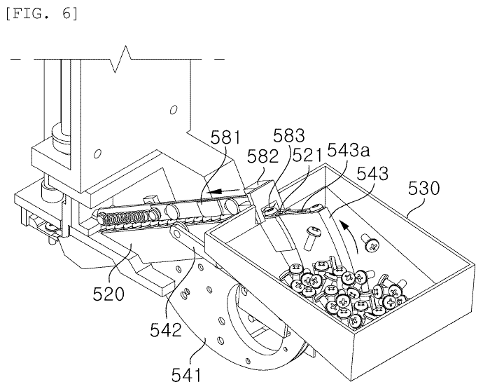

A process of aligning and supplying the fasteners F by the assembly device 500 will be described with reference to FIGS. 5 and 6. FIG. 5 illustrates a state before the fasteners F are aligned and supplied by the assembly device 500, and FIG. 6 illustrates a state in which the fasteners F are aligned and supplied by the assembly device 500.

Referring to FIG. 5, the second side of the rotary plate 543 is located inside the storage box 530 and buried in the fasteners F, while the pusher 582 is pushed to the second end of the rail 520. As the pusher 582 is moved to the second end of the rail 520, the pusher 582 pushes out the fasteners F that are not received in the receiving groove 543a of the rotary plate 543 and drops them into the storage box 530.

Referring to FIG. 6, the second side of the rotary plate 543 is lifted by the rotary bar 542, while the pusher 582 is moved toward the first side of the rail 520. As the rotary plate 543 is lifted, the fasteners F placed on the second side of the rotary plate 543 or received in the receiving groove 543a of the rotary plate 543 are lifted together with the rotary plate 543. Thereafter, the fasteners F received in the receiving groove 543a of the rotary plate 543 are moved to the guide groove 521 of the rail 520 by inclination of the second side of the rotary plate 543, and the fasteners F not received in the receiving groove 543a are not guided to the guide groove 521, but are dropped into the storage box 530 by the pusher 582 when the assembly device 500 returns to the state of FIG. 5.

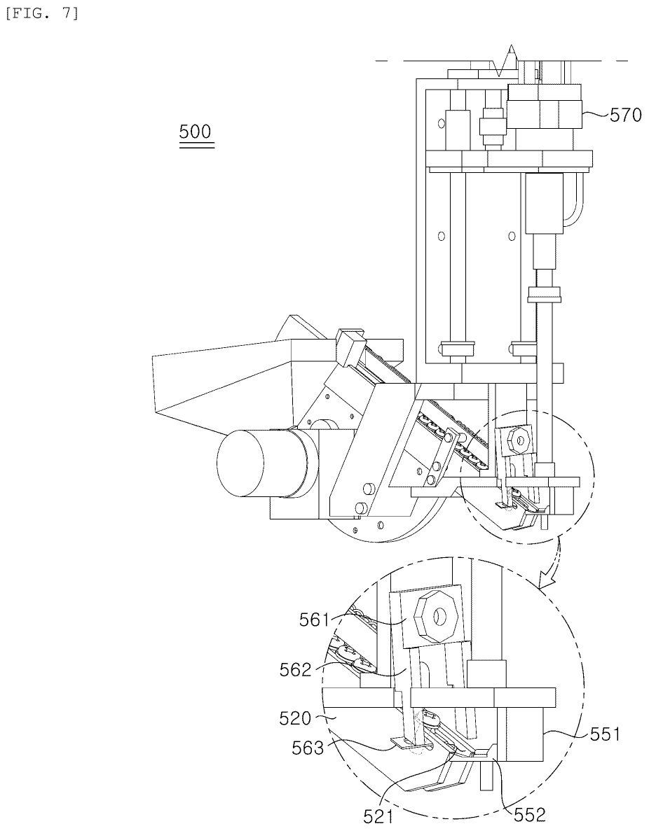

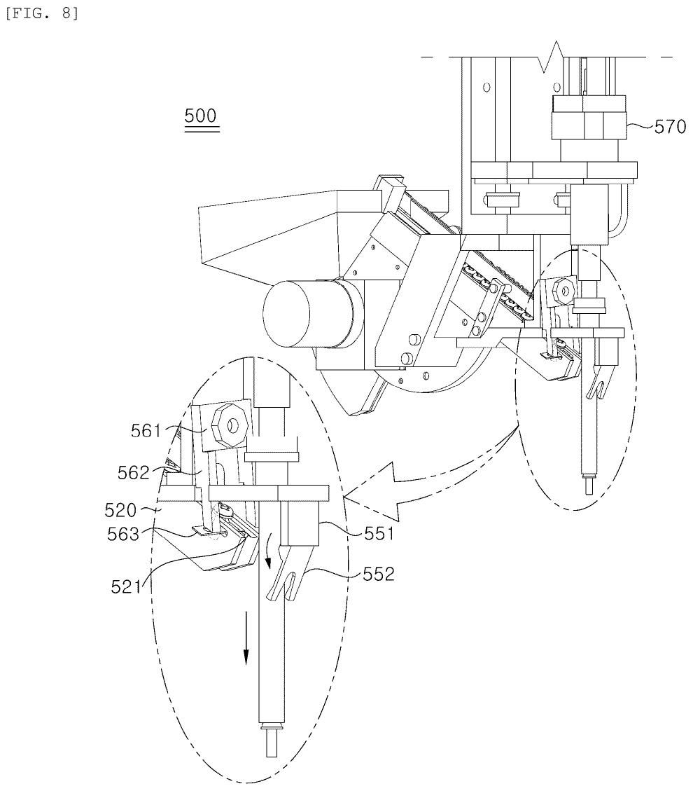

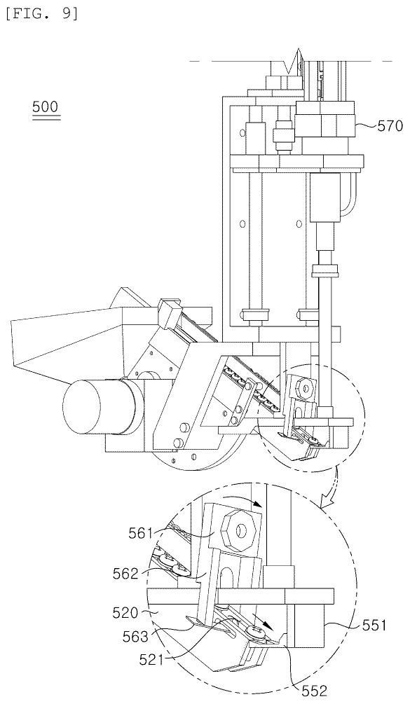

A process of assembling the fasteners F by the assembly device 500 will be described with reference to FIGS. 7 to 9. FIG. 7 illustrates a state before the assembly driver 570 is lowered, and FIG. 8 illustrates a state in which the assembly driver 570 is lowered. FIG. 9 illustrates a state in which the assembly driver 570 is lifted and the fasteners Fare individually withdrawn to the holding plate 550.

Referring to FIG. 7, the end of the assembly driver 570 is located above the holding plate 550, while the leg plate 552 of the holding plate 550 is in a horizontal state. Also, the fasteners F received in the guide groove 521 located at the first end of the rail 520 are restricted from moving by the stopper 563 of the withdrawal unit 560.

Referring to FIG. 8, the end of the assembly driver 570 is lowered, thereby assembling a fastener F located in the holding plate 550 to the crash pad lower assembly panel CP. At this time, the assembly driver 570 is lowered without interference as the leg plate 552 of the holding plate 550 is rotated downward, while the fasteners F received in the guide groove 521 located at the first end of the rail 520 are still restricted from moving by the stopper 563 of the withdrawal unit 560.

Referring to FIG. 9, as the end of the lowered assembly driver 570 is lifted, the leg plate 552 of the holding plate 550 is rotated to its original position. Thereafter, as the rotary frame 561 of the withdrawal unit 560 is rotated, the stopper 563 is removed from the guide groove 521, and one of the fasteners F received in the guide groove 521 located at first end of the rail 520 is supplied to the holding plate 550.

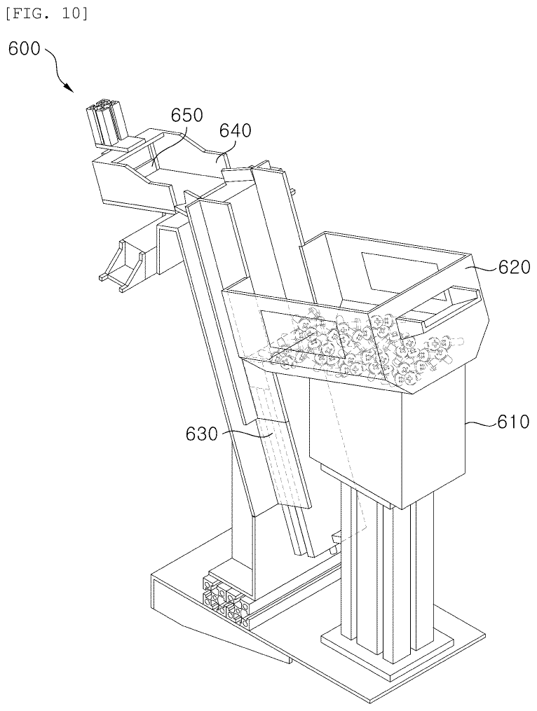

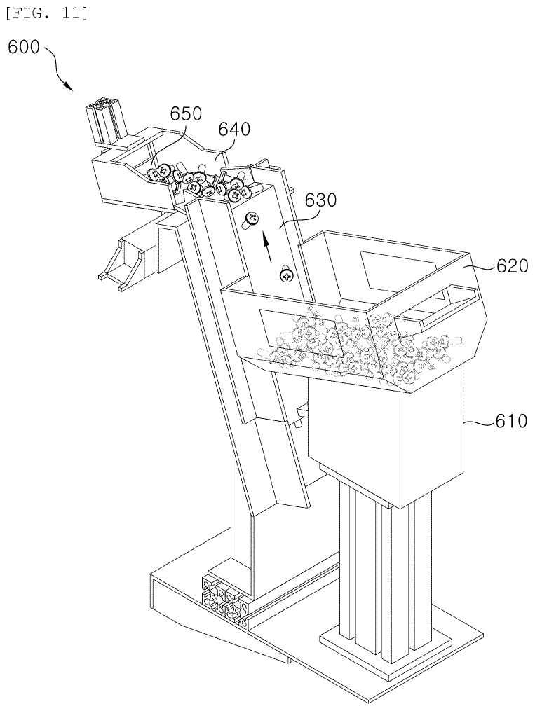

A process of refilling the fasteners F by the refill unit 600 will be described with reference to FIGS. 10 and 11. FIG. 10 illustrates a state before the fasteners F are refilled by the refill unit 600, and FIG. 11 illustrates a state in which the fasteners F are refilled by the refill unit 600.

Referring to FIG. 10, the lifting block 630 is located inside the refill box 620 and is buried in the fasteners F.

Referring to FIG. 11, the lifting block 630 is lifted to a height corresponding to the discharge port 640. As the lifting block 630 is lifted, the fasteners F placed on an upper surface of the lifting block 630 are lifted together with the lifting block 630. Thereafter, the fasteners F are guided to the discharge port 640 by the inclined upper surface of the lifting block 630. The fasteners F guided to the discharge port 640 are blocked by the door 650, and when the storage box 530 is located below the discharge port 640, the door 650 is opened to drop the fasteners F into the storage box 530.

The expressions (terms, visualized images, etc.) used in describing the embodiment of the present disclosure have been merely selected for purpose of enhancing understanding of the technology.

Although the present disclosure has been described by a limited number of embodiments and drawings, a person of ordinary skill in the art will be capable of making various modifications and changes from the above embodiments.

Accordingly, the scope of the present disclosure should not be limited by some expressions appearing in the “DETAILED DESCRIPTION OF THE INVENTION” and the “DRAWINGS”, but should be broadly interpreted on the basis of the original technical ideas inherent in the entire specification.

What is claimed is:

1. An assembly system that assembles accessories to a crash pad lower assembly panel using fasteners, the assembly system comprising:
a work table;
a jig provided on a first side of the upper surface of the work table and configured to support a front surface of the crash pad lower assembly panel;
a pressing rod provided on the work table and configured to pressurize the crash pad lower assembly panel supported on the jig;
an orthogonal robot provided on the work table and configured to be movable in the X-axis and Y-axis above the jig; and
an assembly device coupled to the orthogonal robot.

2. The assembly system of claim 1, wherein the assembly device comprises:
a main frame coupled to the orthogonal robot;
a rail having a first side coupled to a lower end of the main frame and a second side inclined so as to be located higher than the first side, and having a guide groove formed longitudinally on an upper side thereof and configured to guide the fasteners;
a storage box provided at a second end of the rail and configured to store the fasteners therein;
a supply unit configured to be lifted in the storage box and supply the fasteners stored in the storage box to the guide groove located at the second end of the rail;
a holding plate coupled to the lower end of the main frame and located apart from a first end of the rail;
a withdrawal unit coupled to the lower end of the main frame and configured to individually withdraw one by one the fasteners received in the guide groove located at the first end of the rail to the holding plate; and
an assembly driver coupled to the main frame so as to be movable upward and downward and configured to assemble a fastener located in the holding plate by lowering the fastener.

3. The assembly system of claim 2, wherein the supply unit comprises:
a fan-shaped plate coupled to a lower portion of the second side of the rail, with an arc portion thereof facing downward;
a rotary bar having a first side located outside the fan-shaped plate and a second side axially coupled to a center of the fan-shaped plate so as to be rotatable; and
a rotary plate having a first side coupled to the first side of the rotary bar and a second side located in the storage box, and having a receiving groove formed on the second side thereof and configured to allow the fasteners to be received therein,
wherein the rotary plate is lifted inside the storage box by rotation of the rotary bar and supplies the fasteners received in the receiving groove to the guide groove located at the second end of the rail.

4. The assembly system of claim 2, wherein the withdrawal unit comprises:
a rotary frame axially coupled to the lower end of the main frame;
a leg frame extending downward from the rotary frame; and
a stopper coupled to an end of the leg frame and configured to restrict movement of the fasteners located at the first end of the rail,
wherein the stopper restricts movement of the fasteners received in the guide groove located at the first end of the rail by being inserted into or removed from the guide groove located at the first end of the rail by rotation of the rotary frame.

5. The assembly system of claim 2, further comprising:
an alignment unit located above the rail and configured to be moved along the rail to align the fasteners received in the guide groove,
wherein the alignment unit comprises:
a sliding bar located above the rail and configured to be movable along the rail;
a pusher located above the second end of the rail and coupled to the sliding bar; and
a groove formed in the pusher and having a shape corresponding to each of the fasteners,
wherein the pusher aligns the fasteners by pushing out the fasteners coming out of the guide groove by movement of the sliding bar.

6. The assembly system of claim 2, further comprising:
a refill unit provided on the work table and configured to refill the fasteners into the storage box,
wherein the refill unit comprises:
a support installed on an edge of the work table;
a refill box installed at an upper end of the support and inclined so that a first side thereof adjacent to the storage box is located lower than a second side thereof;
a lifting block configured to be lifted along an inner side surface of the refill box;
a discharge port extending outward and downward from a side of an upper end of the refill box; and
a door installed at an end of the discharge port so as to be openable and closable.

7. The assembly system of claim 1, wherein the pressing rod comprises:
an actuator installed on the work table so that a shaft thereof is disposed orthogonal to the work table;
a support coupled orthogonal to the shaft and configured to be rotated and lifted by the actuator; and
a pressure block extending downward from an end of the support.
